(19) United States
(12) Patent Application Publication
(10) Pub. No.: US 2022/0335711 A1
(43) Pub. Date: Oct. 20, 2022

(54) METHOD FOR GENERATING PRE-TRAINED MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Teng XI, Beijing (CN); Gang ZHANG, Beijing (CN)

(21) Appl. No.: 17/853,633

(22) Filed: Jun. 29, 2022

(30) Foreign Application Priority Data
Jul. 29, 2021 (CN) 202110865000.8

(51) Int. Cl. G06V 10/776; G06V 10/80; G06V 10/774; G06V 10/82

(52) U.S. Cl. CPC G06V 10/776; G06V 10/806; G06V 10/774; G06V 10/82

(57) ABSTRACT

A method for generating a pre-trained model, includes: extracting, by each of candidate models that are selected from a model set, features from samples in a test set, to obtain features output by each of the candidate models; obtaining fusion features by fusing features output by the candidate models; obtaining prediction information by performing a preset target recognition task based on the fusion features; determining combination performance of the candidate models based on difference between the prediction information and standard information of the samples; and generating the pre-trained model based on the candidate models in response to the combination performance satisfying a preset performance index.

### CROSS-REFERENCE TO RELATED APPLICATION

This application claims a priority to Chinese Patent Application No. 202110865000.8, filed on Jul. 29, 2021, the entire content of which is incorporated herein by reference.

### TECHNICAL FIELD

The disclosure relates to the field of artificial intelligence technologies, especially to the field of computer vision technologies and deep learning technologies, which can be applicable to scenes such as image processing and image recognition, in particular to a method for generating a pre-trained model, an electronic device and a storage medium.

### BACKGROUND

Currently, the pre-trained model has achieved great successes. The pre-trained model is trained by a large amount of data in the upstream task. Therefore, a better result can be achieved by training based on a small amount of data in the downstream task. However, the pre-trained model in the related art has great limitations in the scene migration and may not satisfy requirements of accuracy. Therefore, how to improve the accuracy of the generated pre-trained model is a technical problem to be solved urgently.

### SUMMARY

According to a first aspect of the disclosure, a method for generating a pre-trained model is provided. The method includes: extracting, by each of candidate models that are selected from a model set, features from samples in a test set, to obtain features output by each of the candidate models; obtaining fusion features by fusing features output by the candidate models; obtaining prediction information by performing a preset target recognition task based on the fusion features; determining combination performance of the candidate models based on difference between the prediction information and standard information of the samples; and generating the pre-trained model based on the candidate models in response to the combination performance satisfying a preset performance index.

According to a second aspect of the disclosure, an electronic device is provided. The electronic device includes: at least one processor and a memory communicatively coupled to the at least one processor. The memory is configured to store instructions executable by the at least one processor, and when the instructions are executed by the at least one processor, the method of the first aspect of the disclosure is performed.

According to a third aspect of the disclosure, a non-transitory computer-readable storage medium having computer instructions stored thereon is provided. The computer instructions are configured to cause a computer to perform the method of the first aspect of the disclosure.

### BRIEF DESCRIPTION OF THE DRAWINGS

The drawings are used to better understand the solutions and do not constitute a limitation to the disclosure, in which:

FIG. 1 is a flowchart of a method for generating a pre-trained model according to some embodiments of the disclosure.

FIG. 2 is a flowchart of another method for generating a pre-trained model according to some embodiments of the disclosure.

FIG. 3 is a flowchart of yet another method for generating a pre-trained model according to some embodiments of the disclosure.

FIG. 4 is a structural diagram of an apparatus for generating a pre-trained model according to some embodiments of the disclosure.

FIG. 5 is a schematic diagram of an example electronic device 500 provided by some embodiments of the disclosure.

### DETAILED DESCRIPTION

The following describes embodiments of the disclosure with reference to the drawings, which includes various details of embodiments of the disclosure to facilitate understanding and shall be considered merely exemplary. Therefore, those of ordinary skill in the art should recognize that various changes and modifications can be made to embodiments described herein without departing from the scope and spirit of the disclosure. For clarity and conciseness, descriptions of well-known functions and structures are omitted in the following description.

A method for generating a pre-trained model, an apparatus for generating a pre-trained model, an electronic device and a storage medium of embodiments of the disclosure are described below with reference to the drawings.

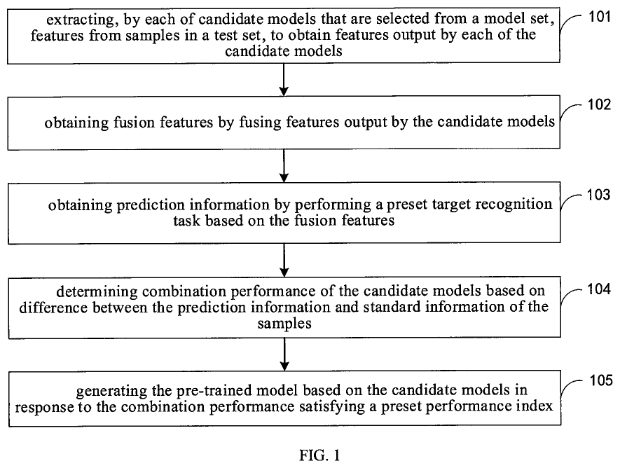

FIG. 1 is a flowchart of a method for generating a pre-trained model according to some embodiments of the disclosure.

As illustrated in FIG. 1, the method includes the following.

In 101, features are extracted from samples in a test set by each of candidate models that are selected from a model set, to obtain features output by each of the candidate models.

In some embodiments of the disclosure, the model set includes a plurality of trained models (that have been trained in advance). The plurality of models can be a plurality of neural network models. The candidate models can be selected from the model set randomly or based on an evolutionary algorithm. The manner of selecting the candidate models is not limited in some embodiments.

The test set includes a large number of test samples. The test samples have been labeled with corresponding standard information in advance. The test samples are related to classification tasks. For example, in a commodity classification task, the test samples can be pictures containing apples, and the standard information of the pictures is labeled with the classification of “apple”. In a human face recognition and classification task, the test samples can be face images labeled with the standard information of “children”.

It should be noted that there is a correspondence between the standard information corresponding to the test samples and target recognition tasks, that is, the standard information corresponding to the samples is different for different target recognition tasks.

In 102, fusion features are obtained by fusing features output by the candidate models.

In some embodiments of the disclosure, for the selected candidate models, according to the samples in the test set, the features extracted independently by each of the candidate models can be obtained, and then the features output by the candidate models are fused. In the first implementation, the features extracted by the candidate models can be fused by a concat function to obtain the fusion features. In the second implementation, the features extracted by the candidate models can be superimposed to obtain the fusion features. For example, 256-dimensional features may be output by each of two candidate models, and 256-dimensional features output by each of the two candidate models can be superimposed to obtain 512-dimensional features. In the third implementation, the features extracted by the candidate models can be dimensionally reduced by a latent dirichlet allocation (LDA) to obtain the fusion features. In the fourth implementation, the features extracted by the candidate models can be dimensionally reduced by a principal components analysis (PCA) to obtain the fusion features.

It should be noted that in some embodiments, the manner of feature fusion for various candidate models is not limited.

In 103, prediction information is obtained by performing a preset target recognition task based on the fusion features.

The preset target recognition tasks, such as a face recognition task and a commodity classification task, can be set according to service requirements, which is not limited in some embodiments.

In an implementation of some embodiments, according to the pre-trained recognition model, the pre-trained recognition model has learned the correspondence between the fusion features and the prediction information, and the fusion features are input into the recognition model to obtain the prediction information output by the model.

The prediction information can be the prediction probability based on the target recognition task. For example, in the commodity classification scenario, the target recognition task is to identify the category of the commodity in the picture, and the prediction information output by the model is that the probability of the commodity being sports shoes is 90%, the probability of the commodity being high heels is 20%, and the probability of the commodity being cloth shoes is 35%.

For example, in the face recognition scene, the target recognition task is to identify whether the face is a certain preset person, for example, the prediction information is that the probability of the face being the person is 92%, and the probability of the face not being the person is 18%.

In 104, combination performance of the candidate models is determined based on difference between the prediction information and standard information of the samples.

In some embodiments of the disclosure, the obtained prediction information is compared with the standard information of the samples to determine the difference between the prediction information and the standard information, and the combination performance of the candidate models is determined according to the difference. The greater the difference, the worse the combination performance of the candidate models, and the smaller the difference, the better the combination performance of the candidate models.

The difference between the prediction information and the standard information can indicate a loss function value, or an accuracy rate, or a recall rate.

In 105, the pre-trained model is generated based on the candidate models in response to the combination performance satisfying a preset performance index.

As an implementation of some embodiments of the disclosure, if the combination performance is determined according to the loss function value, the performance index is set as the loss function value. If the loss function value meets a preset value, the pre-trained model is generated based on the candidate models, that is, the candidate models are combined as the pre-trained model. If the loss function value does not meet the preset value, the candidate models do not meet the condition of generating the pre-trained model.

In another implementation of some embodiments of the disclosure, if the combination performance is determined according to the recognition accuracy, the performance index is set as the accuracy rate. If the accuracy rate meets the preset value of the accuracy rate, the pre-trained model is generated according to the candidate models, that is, the pre-trained model is generated by combining the candidate models. If the accuracy rate does not meet the preset value of the accuracy rate, the candidate models do not meet the condition for generating the pre-trained model, that is, the pre-trained model may not be generated based on the candidate models.

In another implementation of some embodiments of the disclosure, if the combination performance is determined according to the recognition recall rate, the performance index is set as the recall rate. If the recall rate meets the preset value of the recall rate, the pre-trained model is generated based on the candidate models, that is, the pre-trained model is generated by combining the candidate models. If the recall rate does not meet the preset value of the accuracy rate, the candidate models do not meet the condition of generating the pre-trained model, that is, the pre-trained model may not be generated based on the candidate models.

In another implementation of some embodiments of the disclosure, it can also determine whether the combination of the candidate models can be determined as the pre-trained model according to a precise recall rate.

According to the method for generating a pre-trained model according to embodiments of the disclosure, the features are extracted from the samples in the test set by each of the candidate models that are selected from the model set. Fusion features are obtained by fusing the features output by the candidate models. The prediction information is obtained by performing the preset target recognition task based on the fusion features. The combination performance of the candidate models is determined based on the difference between the prediction information and the standard information of the samples. The pre-trained model is generated based on the candidate models in response to the combination performance satisfying the preset performance index. In the disclosure, according to the performance of the combination of the candidate models on the target recognition task, when the combination performance index is satisfied, the combination of the candidate models is determined as the pre-trained model, to improve the accuracy of the pre-trained model.

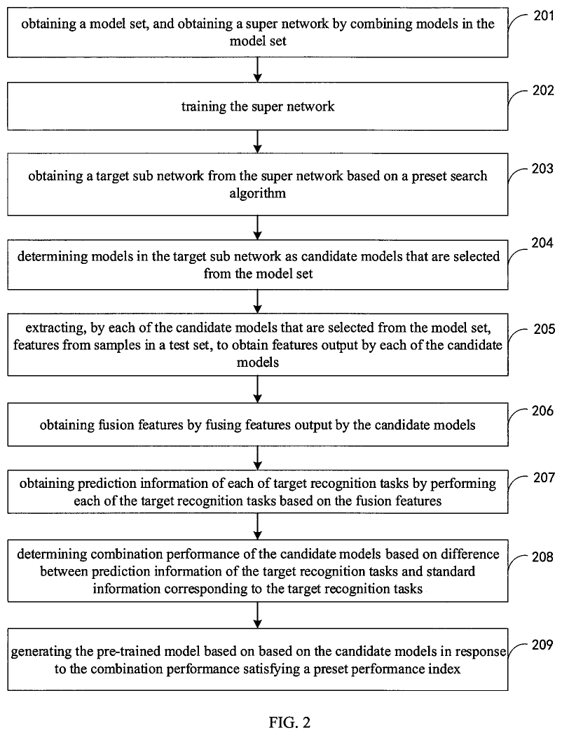

Based on the above embodiments, some embodiments provide another method for generating a pre-trained model, to explain a manner for determining candidate models, and how to determine the performance of the candidate models on the corresponding tasks when there are multiple target recognition tasks. FIG. 2 is a flowchart of another method for generating a pre-trained model according to some embodiments of the disclosure. As illustrated in FIG. 2, the method includes the following.

In 201, a model set is obtained, and a super network is obtained by combining models in the model set.

The super network is a way to accelerate model training. Compared with training each model separately, training the model set improves the speed of model training and generates the correlation and complementary relationship among the models.

In some embodiments of the disclosure, the models in the model set are combined to obtain a plurality of sub networks. In an implementation, the preset number of models can be randomly selected according to the number of models that can be included in the sub network and the corresponding structure of the sub network. The sub network can be obtained based on the randomly selected models through the preset structure combination. In another implementation, based on the number of models that can be included in the sub network and the corresponding structure of the sub network, the preset number of models can be selected based on an evolutionary algorithm, and the sub network can be obtained based on the selected models through the preset structure combination. The super network is generated based on the generated sub networks.

In 202, the super network is trained.

In an implementation of some embodiments of the disclosure, training samples in a training set are input into the super network, and a loss function value of each of the sub networks in the super network is determined according to features output by each of the sub networks. A fusion loss function is obtained by fusing loss function values of the sub networks. As an implementation, the loss function value of each of the sub networks can be fused by means of average weighting to obtain the fusion loss function. As another implementation, the weight of each of the sub networks can be determined according to the preset importance degree of each of the sub networks, that is, the importance degree of each of the sub networks is proportional to the weight. Then the weighted calculation can be carried out according to the weight and the loss function value of each of the sub networks to obtain the fusion loss function. Furthermore, the model parameters of each model in the super network are adjusted according to the fusion loss function, in which the fusion loss function is obtained by fusing the loss function of each of the sub networks. The parameters of each model in the super network are adjusted based on the fusion loss function, so as to finally obtain the trained models, and generate the complementary correlation among the models, thereby making the accuracy of the combined model higher when combining the models and improving the performance of the model combination.

It should be noted that the super network can improve the training speed of each model, because when adjusting the parameters of each model in the super network based on the fusion loss function, the parameters of the models can be adjusted at the same time according to the way of sharing parameters among models, so as to reduce the number of adjustable parameters and improve the training speed of each model as a whole.

The sub network is obtained according to the combination of various models in the model set.

In 203, a target sub network is obtained from the super network based on a preset search algorithm.

In some embodiments of the disclosure, the target sub network is obtained by searching from the super network according to a random search algorithm, an evolutionary search algorithm, an ant colony search algorithm, or a reinforcement learning algorithm. The target sub network is a better model combination determined by search.

In some embodiments of the disclosure, the search algorithm is not limited.

In 204, models in the target sub network are determined as candidate models that are selected from the model set.

In some embodiments of the disclosure, in order to improve the accuracy of each candidate model, model training based on the super network in the above actions is adopted to improve the speed of model training and generate the complementary relationship among models. Then, the better model combination obtained by searching from the super network, that is, the models in the target sub network, are selected as the candidate models in the model set, thus that each model in the target sub network is determined based on search, and then it is determined whether the pre-trained model can be generated, which improves the success rate and reliability of the pre-trained model.

In 205, features are extracted from samples in a test set by each of the candidate models that are selected from the model set, to obtain features output by each of the candidate models.

In 206, fusion features are obtained by fusing features output by the candidate models. 205 and 206 can be explained with reference to 101 and 102 in the above embodiments, and the principle is the same and will not be repeated in some embodiments.

In 207, prediction information of each of target recognition tasks is obtained by performing each of the target recognition tasks based on the fusion features.

There are multiple target recognition tasks.

In some embodiments of the disclosure, the fusion features obtained by fusing the features output by the candidate models are executed with the target recognition tasks respectively to obtain the prediction information of each target recognition task, that is, the performance of various candidate models on each target recognition task can be obtained. Compared with determining the performance on various target recognition tasks for each candidate model, the prediction efficiency is improved.

In 208, combination performance of the candidate models is determined based on difference between prediction information of the target recognition tasks and standard information corresponding to the target recognition tasks.

When the samples in the test set correspond to different target recognition tasks, the samples can have different standard information, that is, the samples in the test set are labeled with the corresponding standard information for different target recognition tasks in advance. In other words, the standard information labeled in the samples has a correspondence with the tasks.

In an implementation of some embodiments of the disclosure, for each of the target recognition tasks, the difference between the prediction information and the standard information of the target recognition task is used to determine the loss function value of the target recognition task. Then, the loss function values of the target recognition tasks are weighted and summed to obtain the total loss function value. According to the total loss function value, the combination performance of the candidate models is determined. According to the total combination performance of the candidate models on the target recognition tasks, the combination performance is indicated by the total loss function value to determine the combination performance, so that the accuracy of the determined combination performance is higher, and the combination of the target candidate models finally determined based on the combination performance can perform better on a variety of target recognition tasks, thereby improving the accuracy of the combined model, and making it suitable for more scenes.

The weighted sum of the above loss function values of the target recognition tasks can be realized in the following ways.

In an implementation, the total loss function value can be obtained by performing average sum on the loss function values of the target recognition tasks.

In another implementation, the weight of each target recognition task can be determined according to the preset importance degree of each target recognition task, that is, the importance degree of each target recognition task is directly proportional to the weight. Then, the total loss function value can be obtained by performing weighted sum on the weight of each target recognition task and the loss function value of each target recognition task.

In another implementation of some embodiments of the disclosure, the recall rate of each target recognition task is determined according to the difference between the prediction information and the standard information of the corresponding task, and the combination performance of the candidate models is determined according to the recall rates of the target recognition tasks, which improves the accuracy of combination performance.

The accuracy rate is used to evaluate the ratio of target results. The recall rate refers to the ratio of recall target categories in the concerned areas. The precise recall rate is the evaluation index of the accuracy rate and the recall rate, which is used to comprehensively reflect the overall index and improve the accuracy of determining the combination performance of the model combination.

In 209, the pre-trained model is generated based on the candidate models in response to the combination performance satisfying a preset performance index.

Details refer to the explanation in the above embodiments, which is not limited in some embodiments.

In the method for generating the pre-trained model of some embodiments, a large-scale pre-training is performed based on the super network, which improves the speed of model training. The possible optimal model combination, i.e., the target sub network, is determined through search from the trained models to determine the combination of candidate models. The candidate models are used to determine the comprehensive performance corresponding to performance of various tasks. According to the correspondence between the combination performance and the preset performance index, the pre-trained model is generated to achieve the higher accuracy at the same speed. Alternatively, under the case of the same accuracy, the speed is faster, which can improve the speed of processing images or audio and video on specific hardware or chip. At the same time, pre-training the models on multiple tasks can solve the technical problem of the limitation of application scenario in the way of pre-training the models on the single task in the related art.

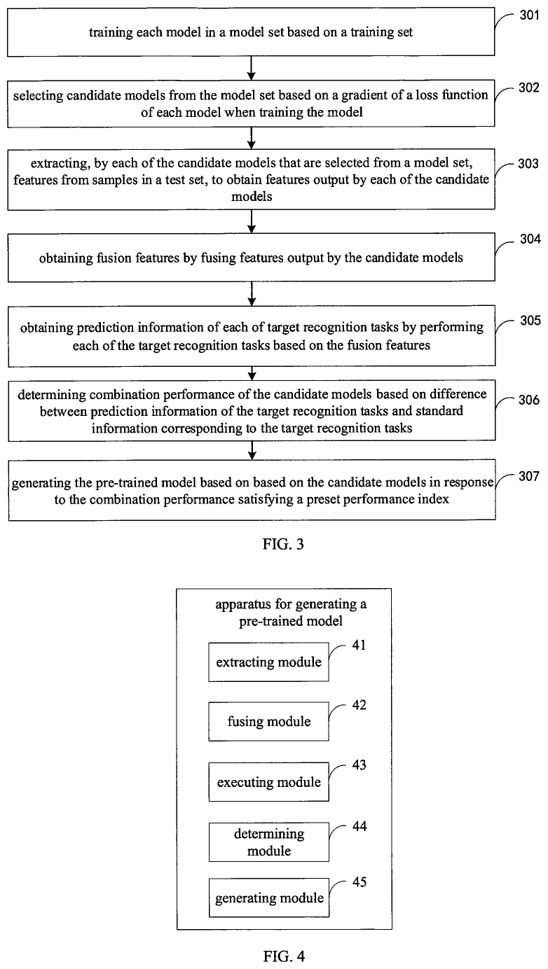

Based on the above embodiments, some embodiments of the disclosure provide another method for determining candidate models. FIG. 3 is a flowchart of yet another method for generating a pre-trained model according to some embodiments of the disclosure. As illustrated in FIG. 3, the method includes the following.

In 301, each model in a model set is trained based on a training set.

In 302, candidate models are selected from the model set based on a gradient of a loss function of each model when training the model.

In some embodiments of the disclosure, the loss function of each model in the model set may be a gradient-based loss function, for example, a model based on differential architecture search (DARTS) architecture. The samples in the training set are used to train various models in the model set respectively, and the candidate models are selected from the model set according to the gradient of the loss function of each model in the model training process. In an implementation, models with similar gradient changes are selected as the candidate models based on the gradient of the loss function of each model. Based on the gradient of the loss function of each model, the candidate models are selected from the model set, and the correlation among the candidate models is established, which improves the reliability of the candidate models.

In 303, features are extracted from samples in a test set by each of the candidate models that are selected from a model set, to obtain features output by each of the candidate models.

In 304, fusion features are obtained by fusing features output by the candidate models.

In 305, prediction information of each of target recognition tasks is obtained by performing each of the target recognition tasks based on the fusion features.

In 306, combination performance of the candidate models is determined based on difference between prediction information of the target recognition tasks and standard information corresponding to the target recognition tasks.

306 can refer to the explanation of 208 in the previous embodiments. The principle is the same and will not be repeated in some embodiments.

In 307, the pre-trained model is generated based on the candidate models in response to the combination performance satisfying a preset performance index.

It should be noted that 303 to 307 can be explained with reference to the above embodiments. The principle is the same, and will not be repeated in some embodiments.

In the method for generating the pre-trained model of some embodiments, a large-scale pre-training is performed on the models, which improves the speed of model training. The possible optimal model combination, i.e., the target sub network, is determined through search from the trained models to determine the combination of candidate models. The candidate models are used to determine the comprehensive performance corresponding to performance of various tasks. According to the correspondence between the combination performance and the preset performance index, the pre-trained model is generated to achieve the higher accuracy at the same speed. Alternatively, under the case of the same accuracy, the speed is faster, which can improve the speed of processing images or audio and video on specific hardware or chip. At the same time, pre-training the models on multiple tasks can solve the technical problem of the limitation of application scenario in the way of pre-training the models on the single task in the related art.

In order to realize the above embodiments, some embodiments provide an apparatus for generating a pre-trained model.

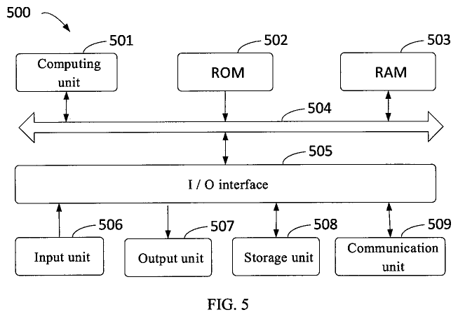

FIG. 4 is a block diagram of another apparatus for generating a pre-trained model according to embodiments of the disclosure. As illustrated in FIG. 4, the apparatus includes: an extracting module 41, a fusing module 42, an executing module 43, a determining module 44 and a generating module 45.

The extracting module 41 is configured to extract, by each of candidate models that are selected from a model set, features from samples in a test set, to obtain features output by each of the candidate models.

The fusing module 42 is configured to obtain fusion features by fusing features output by the candidate models.

The executing module 43 is configured to obtain prediction information by performing a preset target recognition task based on the fusion features.

The determining module 44 is configured to determine combination performance of the candidate models based on difference between the prediction information and standard information of the samples.

The generating module 45 is configured to generate the pre-trained model based on the candidate models in response to the combination performance satisfying a preset performance index.

In an implementation, the apparatus further includes: an obtaining module, a combining module, a first training module and a searching module.

The obtaining module is configured to obtain the model set.

The combining module is configured to obtain a super network by combining models in the model set.

The first training module is configured to train the super network.

The searching module is configured to obtain a target sub network from the super network based on a preset search algorithm.

The determining module 44 is configured to determine models in the target sub network as the candidate models that are selected from the model set.

In an implementation, the first training module is further configured to: input training samples in a training set into the super network; determine a loss function value of each of sub networks in the super network based on features output by each of the sub networks; obtain a fusion loss function by fusing loss function values of the sub networks; and adjust model parameters of each model in the super network based on the fusion loss function.

In an implementation, the apparatus further includes: a second training module and a selecting module.

The second training module is configured to train each model in the model set based on a training set.

The selecting module is configured to select the candidate models from the model set based on a gradient of a loss function of each model when training the model.

In an implementation, there are multiple target recognition tasks, and the determining module 44 is further configured to: determine a loss function value of each target recognition task based on difference between prediction information of the corresponding task and standard information of the corresponding task; obtain a total loss function value by performing weighted sum on loss function values of the multiple target recognition tasks; and determine the combination performance of the candidate models based on the total loss function value.

In an implementation, there are multiple target recognition tasks, and the determining module 44 is further configured to: determine a recall rate of each target recognition task according to difference between prediction information of the corresponding task and standard information of the corresponding task; and determine the combination performance of the candidate models based on recall rates of the multiple target recognition tasks.

It should be noted that the above explanation of the method embodiments is also applicable to the apparatus embodiments, the principle is the same, which will not be repeated in some embodiments.

With the apparatus for generating a pre-trained model according to embodiments of the disclosure, the features are extracted from the samples in the test set by each of the candidate models that are selected from the model set. Fusion features are obtained by fusing the features output by the candidate models. The prediction information is obtained by performing the preset target recognition task based on the fusion features. The combination performance of the candidate models is determined based on the difference between the prediction information and the standard information of the samples. The pre-trained model is generated based on the candidate models in response to the combination performance satisfying the preset performance index. In the disclosure, according to the performance of the combination of the candidate models on the target recognition task, when the combination performance index is satisfied, the combination of the candidate models is determined as the pre-trained model, to improve the accuracy of the pre-trained model.

In order to implement the above embodiments, an electronic device is provided. The electronic device includes: at least one processor and a memory communicatively coupled to the at least one processor. The memory stores instructions executable by the at least one processor, and when the instructions are executed by the at least one processor, the method described in the above method embodiments is implemented.

In order to implement the above embodiments, a non-transitory computer-readable storage medium having computer instructions stored thereon is provided. The computer instructions are configured to cause a computer to implement the method described in the above method embodiments.

In order to implement the above embodiments, a computer program product including computer programs is provided. When the computer programs are executed by a processor, the method described in the above method embodiments is implemented.

According to embodiments of the disclosure, the disclosure also provides an electronic device, a readable storage medium and a computer program product.

FIG. 5 is a block diagram of an example electronic device 500 according to embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examp les, and are not intended to limit the implementation of the disclosure described and/or required herein.

As illustrated in FIG. 5, the device 500 includes a computing unit 501 performing various appropriate actions and processes based on computer programs stored in a read-only memory (ROM) 502 or computer programs loaded from the storage unit 508 to a random-access memory (RAM) 503. In the RAM 503, various programs and data required for the operation of the device 500 are stored. The computing unit 501, the ROM 502, and the RAM 503 are connected to each other through a bus 504. An input/output (I/O) interface 505 is also connected to the bus 504.

Components in the device 500 are connected to the I/O interface 505, including: an inputting unit 506, such as a keyboard, a mouse; an outputting unit 507, such as various types of displays, speakers; a storage unit 508, such as a disk, an optical disk; and a communication unit 509, such as network cards, modems, and wireless communication transceivers. The communication unit 509 allows the device 500 to exchange information/data with other devices through a computer network such as the Internet and/or various telecommunication networks.

The computing unit 501 may be various general-purpose and/or dedicated processing components with processing and computing capabilities. Some examples of computing unit 501 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 501 executes the various methods and processes described above, such as the method for generating a pre-trained model. For example, in some embodiments, the method for generating a pre-trained model may be implemented as a computer software program, which is tangibly contained in a machine-readable medium, such as the storage unit 508. In some embodiments, part or all of the computer program may be loaded and/or installed on the device 500 via the ROM 502 and/or the communication unit 509. When the computer program is loaded on the RAM 503 and executed by the computing unit 501, one or more steps of the method described above may be executed. Alternatively, in other embodiments, the computing unit 501 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve the defects of difficult management and weak business scalability in the traditional physical host and virtual private server (VPS) service. The server can also be a server of distributed system or a server combined with block-chain.

It is noted that AI is a subject that studies the use of computers to simulate certain human thinking processes and intelligent behaviors (such as learning, reasoning, thinking and planning), which has both the hardware-level technology and the software-level technology. AI hardware technology generally includes technologies such as sensor, special AI chip, cloud computing, distributed storage and big data processing. AI software technology mainly includes computer vision, speech recognition technology, natural language processing technology and machine learning/deep learning, big data processing technology and knowledge map technology.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for generating a pre-trained model, comprising:
extracting, by each of candidate models that are selected from a model set, features from samples in a test set, to obtain features output by each of the candidate models;
obtaining fusion features by fusing features output by the candidate models;
obtaining prediction information by performing a preset target recognition task based on the fusion features;
determining combination performance of the candidate models based on difference between the prediction information and standard information of the samples; and
generating the pre-trained model based on the candidate models in response to the combination performance satisfying a preset performance index.

2. The method of claim 1, further comprising:
obtaining the model set;
obtaining a super network by combining models in the model set;
training the super network;
obtaining a target sub network from the super network based on a preset search algorithm; and
determining models in the target sub network as the candidate models that are selected from the model set.

3. The method of claim 2, wherein training the super network comprises:
inputting training samples in a training set into the super network;
determining a loss function value of each of sub networks in the super network based on features output by each of the sub networks;
obtaining a fusion loss function by fusing loss function values of the sub networks; and
adjusting model parameters of each model in the super network based on the fusion loss function.

4. The method of claim 1, further comprising:
training each model in the model set based on a training set; and
selecting the candidate models from the model set based on a gradient of a loss function of each model when training the model.

5. The method of claim 1, wherein there are multiple target recognition tasks, and determining the combination performance of the candidate models based on the difference between the prediction information and the standard information of the samples, comprises:
determining a loss function value of each target recognition task based on difference between prediction information of the corresponding task and standard information of the corresponding task;
obtaining a total loss function value by performing weighted sum on loss function values of the multiple target recognition tasks; and
determining the combination performance of the candidate models based on the total loss function value.

6. The method of claim 1, wherein there are multiple target recognition tasks, and determining the combination performance of the candidate models based on the difference between the prediction information and the standard information of the samples, comprises:
determining a recall rate of each target recognition task according to difference between prediction information of the corresponding task and standard information of the corresponding task; and
determining the combination performance of the candidate models based on recall rates of the multiple target recognition tasks.

7. An electronic device, comprising:
at least one processor; and
a memory communicatively coupled to the at least one processor; wherein,
the memory is configured to store instructions executable by the at least one processor, when the instructions are executed by the at least one processor, the at least one processor is enabled to perform:
extracting, by each of candidate models that are selected from a model set, features from samples in a test set, to obtain features output by each of the candidate models;
obtaining fusion features by fusing features output by the candidate models;
obtaining prediction information by performing a preset target recognition task based on the fusion features;
determining combination performance of the candidate models based on difference between the prediction information and standard information of the samples; and
generating the pre-trained model based on the candidate models in response to the combination performance satisfying a preset performance index.

8. The electronic device of claim 7, wherein when the instructions are executed by the at least one processor, the at least one processor is enabled to perform:
obtaining the model set;
obtaining a super network by combining models in the model set;
training the super network;
obtaining a target sub network from the super network based on a preset search algorithm; and
determining models in the target sub network as the candidate models that are selected from the model set.

9. The electronic device of claim 8, wherein when the instructions are executed by the at least one processor, the at least one processor is enabled to perform:
inputting training samples in a training set into the super network;
determining a loss function value of each of sub networks in the super network based on features output by each of the sub networks;
obtaining a fusion loss function by fusing loss function values of the sub networks; and
adjusting model parameters of each model in the super network based on the fusion loss function.

10. The electronic device of claim 7, wherein when the instructions are executed by the at least one processor, the at least one processor is enabled to perform:
training each model in the model set based on a training set; and
selecting the candidate models from the model set based on a gradient of a loss function of each model when training the model.

11. The electronic device of claim 7, wherein when the instructions are executed by the at least one processor, the at least one processor is enabled to perform:
determining a loss function value of each target recognition task based on difference between prediction information of the corresponding task and standard information of the corresponding task;
obtaining a total loss function value by performing weighted sum on loss function values of the multiple target recognition tasks; and
determining the combination performance of the candidate models based on the total loss function value.

12. The electronic device of claim 7, wherein when the instructions are executed by the at least one processor, the at least one processor is enabled to perform:
determining a recall rate of each target recognition task according to difference between prediction information of the corresponding task and standard information of the corresponding task; and
determining the combination performance of the candidate models based on recall rates of the multiple target recognition tasks.

13. A non-transitory computer-readable storage medium having computer instructions stored thereon, wherein the computer instructions are configured to cause a computer to perform:
extracting, by each of candidate models that are selected from a model set, features from samples in a test set, to obtain features output by each of the candidate models;
obtaining fusion features by fusing features output by the candidate models;
obtaining prediction information by performing a preset target recognition task based on the fusion features;
determining combination performance of the candidate models based on difference between the prediction information and standard information of the samples; and
generating the pre-trained model based on the candidate models in response to the combination performance satisfying a preset performance index.

14. The non-transitory computer-readable storage medium of claim 13, wherein the computer instructions are configured to cause a computer to perform:
obtaining the model set;
obtaining a super network by combining models in the model set;
training the super network;
obtaining a target sub network from the super network based on a preset search algorithm; and
determining models in the target sub network as the candidate models that are selected from the model set.

15. The non-transitory computer-readable storage medium of claim 14, wherein the computer instructions are configured to cause a computer to perform:
inputting training samples in a training set into the super network;
determining a loss function value of each of sub networks in the super network based on features output by each of the sub networks;
obtaining a fusion loss function by fusing loss function values of the sub networks; and
adjusting model parameters of each model in the super network based on the fusion loss function.

16. The non-transitory computer-readable storage medium of claim 13, wherein the computer instructions are configured to cause a computer to perform:
training each model in the model set based on a training set; and
selecting the candidate models from the model set based on a gradient of a loss function of each model when training the model.

17. The non-transitory computer-readable storage medium of claim 13, wherein the computer instructions are configured to cause a computer to perform:
determining a loss function value of each target recognition task based on difference between prediction information of the corresponding task and standard information of the corresponding task;
obtaining a total loss function value by performing weighted sum on loss function values of the multiple target recognition tasks; and
determining the combination performance of the candidate models based on the total loss function value.

18. The non-transitory computer-readable storage medium of claim 13, wherein the computer instructions are configured to cause a computer to perform:
determining a recall rate of each target recognition task according to difference between prediction information of the corresponding task and standard information of the corresponding task; and
determining the combination performance of the candidate models based on recall rates of the multiple target recognition tasks.
